(19) United States
(12) Patent Application Publication
(10) Pub. No.: US 2005/0111426 A1
(43) Pub. Date: May 26, 2005

(54) Wireless network and wireless access terminals using optimized transmission of SYNC_ID parameter

(75) Inventor: Purva R. Rajkotia, Plano, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 10/954,597

(22) Filed: Sep. 30, 2004

Related U.S. Application Data
(60) Provisional application No. 60/525,477, filed on Nov. 26, 2003.

(51) Int. Cl. H04M 11/04

(52) U.S. Cl. 370/342

(57) ABSTRACT

A base station for use in a wireless network capable of communicating with a plurality of mobile stations according to the CDMA2000 standard. The base station generates a SYNC_ID parameter based on at least one service configuration record (SCR) value and independent of a non-negotiable service configuration record (NNSCR) value. The SYNC_ID parameter uses SCR values associated with at least one most common configuration of the wireless network. The base station also compresses the SYNC_ID parameter prior to transmission to a mobile station.

### CROSS-REFERENCE TO RELATED APPLICATION AND CLAIM OF PRIORITY

The present invention is related to that disclosed in U.S. Provisional patent application Ser. No. 60/525,477, filed Nov. 26, 2003, entitled “Wireless Network and Wireless Access Terminals Using Optimized Transmission of SYNC_ID Parameter”. U.S. Provisional patent application Ser. No. 60/525,477 is assigned to the assignee of the present application. The subject matter disclosed in U.S. Provisional patent application Ser. No. 60/525,477 is hereby incorporated by reference into the present disclosure as if fully set forth herein. The present invention hereby claims priority under 35 U.S.C. §119(e) to U.S. Provisional patent application Ser. No. 60/525,477.

### TECHNICAL FIELD OF THE INVENTION

The present invention is directed generally to wireless networks and, more specifically, to CDMA2000 wireless network base stations and wireless mobile stations that optimize the transmission of the SYNC_ID parameter.

### BACKGROUND OF THE INVENTION

Businesses and consumers use a wide variety of fixed and mobile wireless terminals, including cell phones, pagers, personal communication services (PCS) devices, and fixed wireless access devices (e.g., vending machine with wireless capability). Wireless service providers continually try to create new markets for wireless devices and expand existing markets by making wireless devices and services cheaper and more reliable. As consumers place greater emphasis on network performance, wireless service providers seek a competitive edgy by improving the reliability of their networks in many different ways.

Code division multiple access (CDMA) wireless network use a parameter called the synchronization identifier. (or SYNC_ID) to set up communication links with wireless access terminals (or mobile stations), such as cell phones. The SYNC_ID is a variable-length signature code for the Service Configuration Record (SCR) parameters and the Non-Negotiable Service Configuration Record (NNSCR) parameters. A base station in a wireless network specifies the length of the SYNC_ID parameter to a mobile station when the mobile station attempts to access the wireless network. CDMA wireless networks use the SYNC_ID parameter to reduce the negotiation time between the mobile station and the base station during a call set-up procedure. Without the SYNC_ID parameter, a call set-up operation would require anywhere from an extra few hundred milliseconds up to several extra seconds.

The generation of signature codes is not standardized among vendors. Each base station vendor generates its own signature code. Thus, it is possible for two identical signature codes from two different vendors to map to two different configurations. Under the latest release of the CDMA2000 standards, a mobile station is required to store at least four SYNC_ID values (or signature codes). The scope of each SYNC_ID parameter value may extend anywhere from one BTS to an entire network. Each base station vendor limits the scope of this signature.

By way of example, in one embodiment of the prior art, the SYNC_ID parameter may be a 16-bit CRC computed over the entire SCR and NNSCR parameters. The mobile station computes this value and transmits it to the base station in the Origination message or the Page Response message. The base station then calculates the SCR and NNSCR parameters sent by the mobile station from the received SYNC_ID parameter and, if the values are not supported by the base station, the base station transmits the correct SCR parameters and NNSCR parameters to the mobile station in a Service Connect message.

Conventional techniques for using the SYNC_ID parameter are problematic. As noted, the SYNC_ID parameter is a variable-length signature code for the SCR and the NNSCR parameters. Since the format of the SYNC_ID parameter is not clearly defined, any amount of information may be transmitted within the SYNC_ID parameter. This may cause undue loading of the air interface. This also may cause problems regarding the scope, the usability or the interpretation of the information carried in the SYNC_ID parameter. Since the SYNC_ID parameter is intended to provide faster call setup, the smaller the size of the SYNC_ID parameter, the faster the call setup will be.

Therefore, there is a need in the art for improved wireless networks and improved wireless terminals for accessing the wireless networks. In particular, there is a need for CDMA2000 wireless network base stations and wireless mobile stations that optimize the transmission of the SYNC_ID parameter in order to improve call set-up time.

### SUMMARY OF THE INVENTION

The present invention overcomes the shortcomings of conventional wireless networks by providing a technique that omits the NNSCR parameters from the SYNC_ID parameter and optimizes the parameters sent as part of the SCR. The present invention also discloses the compression and decompression of the SYNC_ID information at the sending and the receiving end. Thus, only compressed information is sent over the air, thereby saving bandwidth.

To address the above-discussed deficiencies of the prior art, it is a primary object of the present invention to provide a base station for use in a wireless network capable of communicating with a plurality of mobile stations according to the CDMA2000 standard. According to an advantageous embodiment, the base station is capable of generating a SYNC_ID parameter based on at least one service configuration record (SCR) value and independent of a non-negotiable service configuration record (NNSCR) value.

According to one embodiment of the present invention, the base station generates the SYNC_ID parameter using SCR values associated with at least one most common configuration of the wireless network.

According to another embodiment of the present invention, the base station compresses the SYNC_ID parameter prior to transmission to a first one of the plurality of mobile stations.

According to still another embodiment of the present invention, the base station transmits the compressed SYNC_ID parameter to the first mobile station in a Service Connect message.

According to yet another embodiment of the present invention, the base station is further capable of receiving a compressed SYNC_ID parameter from the first mobile station.

According to a further embodiment of the present invention, the base station is further capable of decompressing the compressed SYNC_ID parameter and comparing a value of the decompressed SYNC_ID parameter to at least one accepted SYNC_ID parameter value associated with the base station.

According to a still further embodiment of the present invention, the base station transmits the NNSCR value to the first mobile station in a control channel message separate from a control message used to transmit the SYCN_ID parameter.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network in which optimizes the transmission of the SYNC_ID parameter according to the principles of the present invention;

FIG. 2 illustrates an exemplary base station in greater detail according to an exemplary embodiment of the present invention;

FIG. 3 is a flow diagram illustrating transmission of optimized SYNC_ID parameters according to the principles of the present invention.

### DETAILED DESCRIPTION OF THE INVENTION

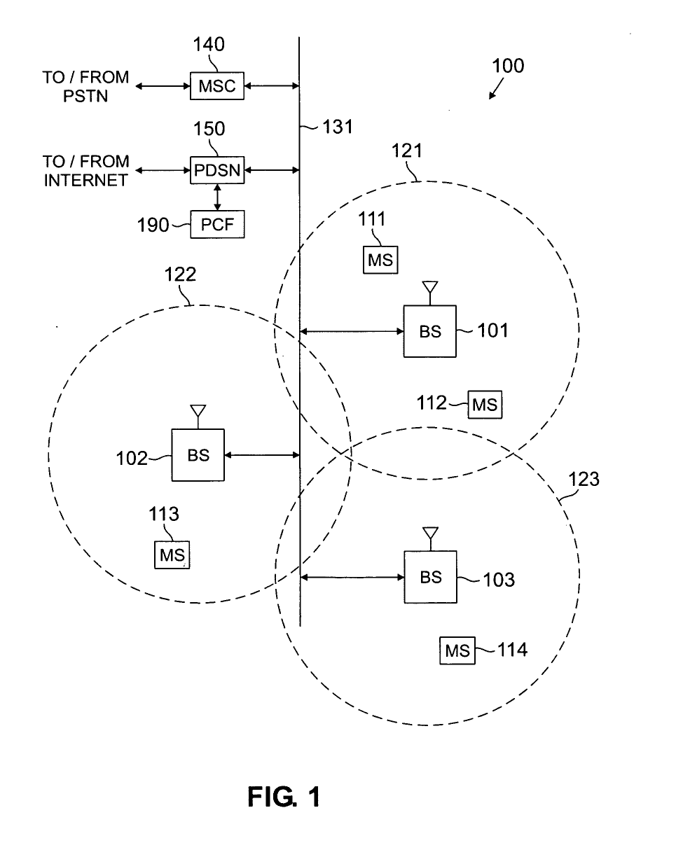

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100, which optimizes the transmission of the SYNC_ID parameter according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to the IS-2000 standard (i.e., CDMA2000), including, for example, Release C or later of the CDMA2000 standard. Mobile stations 111-114 may be any suitable wireless devices, including conventional cellular radiotelephones, PCS handset devices, personal digital assistants, portable computers, telemetry devices, and the like, which are capable of communicating with the base stations via wireless links.

The present invention is not limited to mobile devices. Other types of wireless access terminals, including fixed wireless terminals, may be used. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., monitoring devices with wireless capability).

Dotted lines show the approximate boundaries of the cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, cell sites 121-123 are comprised of a plurality of sectors (not shown), where a directional antenna coupled to the base station illuminates each sector. The embodiment of FIG. 1 illustrates the base station in the center of the cell. Alternate embodiments position the directional antennas in corners of the sectors. The system of the present invention is not limited to any particular cell site configuration.

In one embodiment of the present invention, BS 101, BS 102, and BS 103 comprise a base station controller (BSC) and at least one base transceiver subsystem (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystem in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of base stations 101-103, or as a stand-alone device that communicates with PDSN 150, as shown in FIG. 1. Line 131 also provides the connection path to transfer control signals between MSC 140 and BS 101, BS 102 and BS 103 used to establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

To improve system performance and minimize dropped calls, wireless network 100 and the mobile stations accessing wireless network 100 optimize the transmission of the SYNC_ID parameter according to the principles of the present invention. The present invention optimizes the format of the SYNC_ID parameter, so that the mobile station may correctly interpret the information and at the same time give the base station vendor flexibility to transmit the pertinent information. The definition of the SYNC_ID parameter format must consider the most widely used SCR/NNSCR configurations.

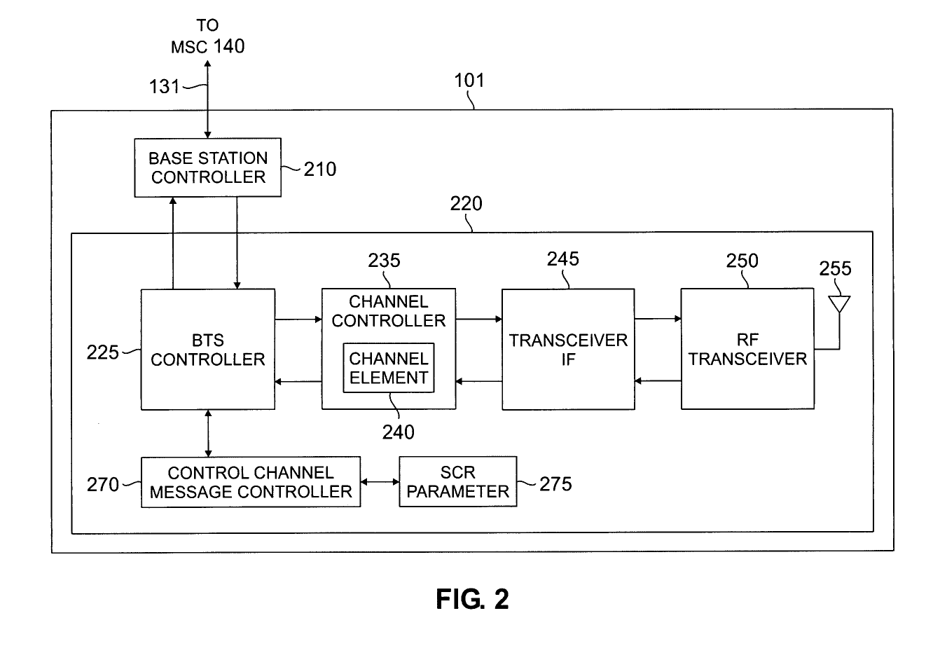

FIG. 2 illustrates exemplary base station 101 in greater detail according to an exemplary embodiment of the present invention. Base station 101 comprises base station controller (BSC) 210 and base transceiver station (BTS) 220. Base station controllers and base transceiver stations were described previously in connection with FIG. 1. BSC 210 manages the resources in cell site 121, including BTS 220. BTS 120 comprises BTS controller 225, channel controller 235 (which contains representative channel element 240), transceiver interface (IF) 245, RF transceiver unit 250, antenna array 255, control channel message controller 270, and SCR parameter information 275.

BTS controller 225 comprises processing circuitry and memory capable of executing an operating program that controls the overall operation of BTS 220 and communicates with BSC 210. Under normal conditions, BTS controller 225 directs the operation of channel controller 235, which contains a number of channel elements, including channel element 240, that perform bi-directional communications in the forward channel and the reverse channel. A forward channel refers to outbound signals from the base station to the mobile station and a reverse channel refers to inbound signals from the mobile station to the base station. Transceiver IF 245 transfers the bi-directional channel signals between channel controller 240 and RF transceiver unit 250.

Antenna array 255 transmits forward channel signals received from RF transceiver unit 250 to mobile stations in the coverage area of BS 101. Antenna array 255 also sends to transceiver 250 reverse channel signals received from mobile stations in the coverage area of BS 101. In a preferred embodiment of the present invention, antenna array 255 is multi-sector antenna, such as a three-sector antenna in which each antenna sector is responsible for transmitting and receiving in a 120° arc of coverage area. Additionally, transceiver 250 may contain an antenna selection unit to select among different antennas in antenna array 255 during both transmit and receive operations.

Control channel message controller 270 controls the generation and transmission of control channel message to mobile stations 111-114, including Service Connect messages that contain SYNC_ID parameters. According to the principles of the present invention, control channel message controller 270 generates the SYNC_ID parameter based only on the SCR parameter 275. Control channel message controller 270 transmits the NNSCR parameter to mobile stations 111-114 using a new overhead control message, rather than the SYNC_ID parameter.

To determine the optimum length of the SYNC_ID parameter, the SCR and NNSCR parameters are examined. The NNSCR parameters are Non-Negotiable Service Configuration Record parameters, which are unique to each wireless network. The NNSCR parameters do not need to be transmitted repeatedly over the air. Thus, control channel message controller 270 transmits the NNSCR parameters from base station 101 to a mobile station using a new overhead message that carries the NNSCR parameters. The new overhead message carrying the NNSCR parameters only needs to be transmitted once over the air within a particular system ID/network ID (SID/NID) boundary.

Since the mobile station receives the NNSCR parameters by the new overhead message, the NNSCR parameters do not need to be part of the SYNC_ID parameter. Thus, the length of the SYNC_ID parameter is reduced. The present invention also optimizes the format of the SCR parameters. Among the standard SCR parameters, the most important parameter values are as follows:
1. Voice/circuit/SMS calls (22 bits):
a) SO=16 bits; and
b) FOR_RC=5 bits.
2. Packet data call (forward, reverse/1-39 2-55/, forward & reverse/1-57/):
a) SO=16 bits;
b) FCH_or_DCCH=2 bits (FCH=01, DCCH=10, both=11);
c) FOR_RC=5 bits;
d) SCH Direction=2 bits (forward=01, reverse=10, both=11);
e) NUM_FOR_SCH (0 or 2 bits)—usually only 1;
f) CH_MUX_OPTION[2]=16 bits;
g) NUM_REV_SCH (0 or 2 bits)—usually only 1;
h) SCH_MUX_OPTION[2]=16 bits;
i) RLP_INFO_INCL=1 bit;
j) RLP_BLOB_LEN=0 or 2 bits; and
k) RLP_BLOB=(record).

For the values above, it is assumed that: i) all the channels operate in a single radio configuration (RC) and ii) the FCH/DCCH/both MUX options may be derived from the FOR_MUX_OPTION/RC).
3. PDCH call (55 bits):
a) SO=16 bits;
b) FCH_or_DCCH=2 bits (FCH=01, DCCH=_{10,} both=₁₁);
c) FDCH_MUX_OPTION=16 bits;
d) PDCH_MUX_OPTION=16 bits; and
e) FOR_PDCH_RC=5 bits.

For the values above, it is assumed that: i) the FCH and DCCH will operate for the same MUX option if both exist together and ii) the supplemental channel (SCH) is not allocated if the Packet Data channel (PDCH) is allocated.
4. Concurrent service:
a) SO/TYPE=concurrent services (16 bits); and
b) NUM_CONN_REC=3 (max. of 7 concurrent services).

The four most widely accepted configurations are stated above. Thus, only those parameters that must be sent for a given call are transmitted, rather than sending all the information or setting the bits to Logic 0, as is currently done. This technique enables the present invention to save bits for the SCR parameter. Thus, the present invention saves the information bits to be transmitted on the SYNC_ID parameter by compressing the SCR and the NNSCR parameters.

The present invention also proposes to reduce the size of the SYNC_ID parameter by compressing the SYNC_ID parameter transmitted by the base station and the mobile station using a compression algorithm. The base station and the mobile station must also have the capability to decompress the information received. Using this techniques provided by the present invention, there will be no need to classify the most widely used configuration, since all the data transmitted over the air will be compressed and would not consume a large amount of resources on the air interface.

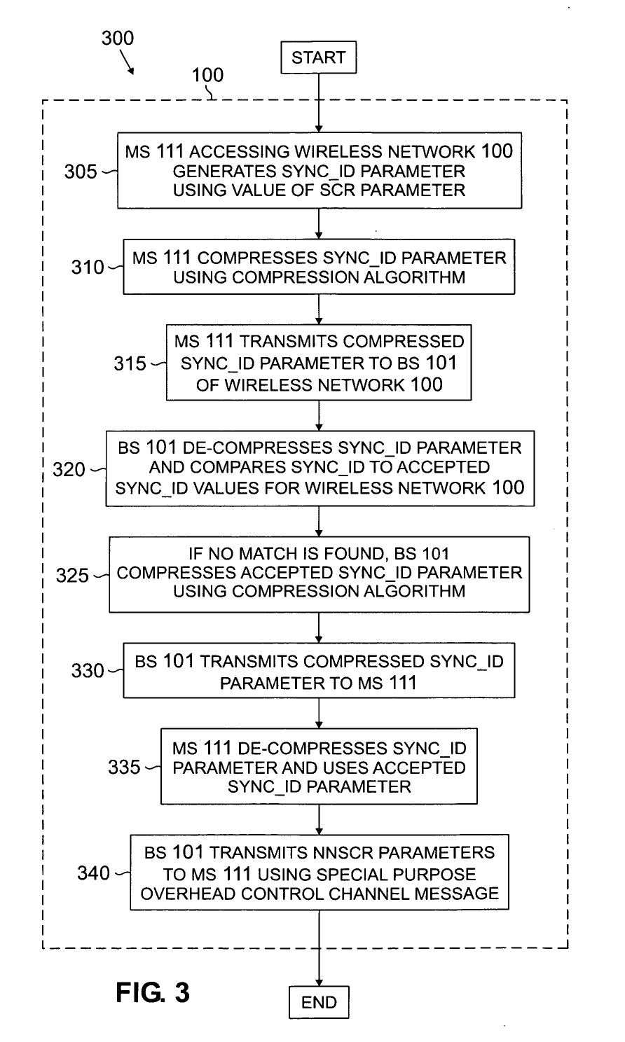

FIG. 3 depicts flow diagram 300, which illustrates the transmission of optimized SYNC_ID parameters according to the principles of the present invention. Initially, a mobile station (e.g., MS 111) accessing wireless network 100 generates a SYNC_ID parameter using the values of the SCR parameters, but not the NNSCR parameters (process step 305). Prior to transmission, MS 111 compresses the SYNC_ID parameter using a conventional compression algorithm (process step 310). MS 111 then transmits the compressed SYNC_ID parameter to BS 101 of wireless network 100 (process step 315).

BS 101 de-compresses the compressed SYNC_ID parameter and compares the value of the SYNC_ID parameter to one or more accepted SYNC_ID values for BS 101 of wireless network 100 (process step 320). If no match is found, BS 101 compresses an accepted SYNC_ID parameter using a conventional compression algorithm (process step 325). BS 101 then transmits the compressed accepted SYNC_ID parameter to MS 111 (process step 330). MS 111 de-compresses the SYNC_ID parameter and uses the accepted SYNC_ID parameter (process step 335). Subsequently, BS 101 may transmit one or more NNSCR parameters to MS 111 using a special purpose overhead control channel message (process step 340).

Although the present invention has been described with an exemplary embodiment, various changes and modifications may be suggested to one skilled in the art. It is intended that the present invention encompass such changes and modifications as fall within the scope of the appended claims.

1. For use in a wireless network capable of communicating with a plurality of mobile stations according to the CDMA2000 standard, a base station capable of generating a SYNC_ID parameter based on at least one service configuration record (SCR) value and independent of a non-negotiable service configuration record (NNSCR) value.

2. The base station as set forth in claim 1, wherein said base station generates said SYNC_ID parameter using SCR values associated with at least one most common configuration of said wireless network.

3. The base station as set forth in claim 2, wherein said base station compresses said SYNC_ID parameter prior to transmission to a first one of said plurality of mobile stations.

4. The base station as set forth in claim 3, wherein said base station transmits said compressed SYNC_ID parameter to said first mobile station in a Service Connect message.

5. The base station as set forth in claim 4, wherein said base station is further capable of receiving a compressed SYNC_ID parameter from said first mobile station.

6. The base station as set forth in claim 5, wherein said base station is further capable of decompressing said compressed SYNC_ID parameter and comparing a value of said decompressed SYNC_ID parameter to at least one accepted SYNC_ID parameter value associated with said base station.

7. The base station as set forth in claim 6, wherein said base station transmits said NNSCR value to said first mobile station in a control channel message separate from a control message used to transmit said SYNC_ID parameter.

8. A wireless network comprising a plurality of base station capable of communicating with a plurality of mobile stations according to the CDMA2000 standard, wherein each of said base stations is capable of generating a SYNC_ID parameter based on at least one service configuration record (SCR) value and independent of a non-negotiable service configuration record (NNSCR) value.

9. The wireless network as set forth in claim 8, wherein said base station generates said SYNC_ID parameter using SCR values associated with at least one most common configuration of said wireless network.

10. The wireless network as set forth in claim 9, wherein said base station compresses said SYNC_ID parameter prior to transmission to a first one of said plurality of mobile stations:

11. The wireless network as set forth in claim 10, wherein said base station transmits said compressed SYNC_ID parameter to said first mobile station in a Service Connect message.

12. The wireless network as set forth in claim 11, wherein said base station is further capable of receiving a compressed SYNC_ID parameter from said first mobile station.

13. The wireless network as set forth in claim 12, wherein said base station is further capable of decompressing said compressed SYNC_ID parameter and comparing a value of said decompressed SYNC_ID parameter to at least one accepted SYNC_ID parameter value associated with said base station.

14. The wireless network as set forth in claim 13, wherein said base station transmits said NNSCR value to said first mobile station in a control channel message separate from a control message used to transmit said SYNC_ID parameter.

15. A mobile station capable of accessing a wireless network according to the CDMA2000 standard, where the mobile station is capable of generating a SYNC_ID parameter based on at least one service configuration record (SCR) value and independent of a non-negotiable service configuration record (NNSCR) value.

16. The mobile station as set forth in claim 15, wherein said mobile station generates said SYNC_ID parameter using SCR values associated with at least one most common configuration of said wireless network.

17. The mobile station as set forth in claim 16, wherein said mobile station compresses said SYNC_ID parameter prior to transmission to a base station associated with said wireless network.

18. The mobile station as set forth in claim 17, wherein said mobile station transmits said compressed SYNC_ID parameter to said base station in at least one of an Origination message and a Page Response message.

19. The mobile station as set forth in claim 18, wherein said mobile station is further capable of receiving a compressed SYNC_ID parameter from said base station.

20. The mobile station as set forth in claim 19, wherein said mobile station is further capable of decompressing said compressed SYNC_ID parameter and comparing a value of said decompressed SYNC_ID parameter to at least one accepted SYNC_ID parameter value associated with said base station.

21. The mobile station as set forth in claim 20, wherein said mobile station receives said NNSCR value from said base station in a control channel message separate from a control message used to transmit said compressed SYNC_ID parameter.
